(19) United States
(12) Patent Application Publication
(10) Pub. No.: US 2026/0228645 A1
(43) Pub. Date: Aug. 6, 2026

(54) SELECTIVE MACHINE LEARNING MODEL DEPLOYMENT USING PREDICTED ADJUSTMENTS TO AN ITEM GROUPING

(71) Applicant: Dell Products L.P., Round Rock, TX (US)

(72) Inventors: Sumit Wadhwa, Austin, TX (US); Prateek Srivastava, Cedar Park, TX (US); Victor Caetano, Belo Horizonte (BR)

(21) Appl. No.: 19/046,696

(22) Filed: Feb. 6, 2025

(51) Int. Cl. G06N 20/20

(52) U.S. Cl. CPC G06N 20/20

(57) ABSTRACT

Techniques are provided for selective machine learning (ML) model deployment using predicted adjustments to an item grouping. One method comprises accessing information characterizing an item grouping; applying portions of the accessed information to (i) a first score prediction model and (ii) a second score prediction model to obtain data characterizing respective predicted scores for the item grouping; applying portions of the obtained data to an item grouping adjustment prediction model to obtain respective predicted adjustments to parameters of the item grouping; applying portions of the respective predicted adjustments to a selective model deployment system to obtain a deployment decision, where the selective model deployment system evaluates a performance of (i) the first score prediction model and (ii) the second score prediction model, based on the respective predicted adjustments to the parameters of the item grouping, to determine the deployment decision; and initiating processing steps based on the deployment decision.

### BACKGROUND

Machine learning (ML) models are increasingly employed in various settings within companies and other organizations. Such models may be used to evaluate one or more properties of a collection of items, for example, as well as for cybersecurity threat detection, facial recognition and other potentially sensitive and important tasks.

### SUMMARY

Illustrative embodiments of the disclosure provide techniques for selective ML model deployment using predicted adjustments to an item grouping. One method includes accessing at least one data structure, wherein the at least one data structure corresponds to an item grouping of one or more items and comprises a plurality of feature values related to the item grouping; applying at least portions of the data structure to (i) at least one first machine learning (ML)-based score prediction model and (ii) at least one second ML-based score prediction model to obtain data characterizing respective predicted scores for the item grouping; applying at least portions of the respective predicted scores for the item grouping to at least one ML-based item grouping adjustment prediction model to obtain respective predicted adjustments to one or more parameters of the item grouping; applying at least portions of the respective predicted adjustments to at least one processor-based selective model deployment system to obtain data characterizing a deployment decision, wherein the at least one processor-based selective model deployment system evaluates a performance of (i) the at least one first ML-based score prediction model and (ii) the at least one second ML-based score prediction model, based at least in part on the respective predicted adjustments to the one or more parameters of the item grouping, to determine the deployment decision; and initiating one or more processing steps based at least in part on the deployment decision.

Illustrative embodiments can provide significant advantages relative to conventional techniques. For example, technical problems related to such conventional techniques are mitigated in one or more embodiments by processing predicted adjustments to an item grouping to evaluate ML models.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for selective ML model deployment using predicted adjustments to an item grouping in accordance with an illustrative embodiment;

FIG. 2 illustrates a training of the ML-based item grouping adjustment prediction models of FIG. 1 in accordance with an illustrative embodiment;

FIG. 3 illustrates an evaluation of the ML-based item grouping scoring models of FIG. 1 in accordance with an illustrative embodiment;

FIG. 4 illustrates exemplary pseudocode for a selective ML model deployment process in accordance with an illustrative embodiment;

FIGS. 5 and 6 are flow diagrams illustrating exemplary implementations of processes for selective ML model deployment using predicted adjustments to an item grouping in accordance with an illustrative embodiment;

FIG. 7 illustrates an exemplary processing platform that may be used to implement at least a portion of one or more embodiments of the disclosure comprising a cloud infrastructure; and

FIG. 8 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for selective ML model deployment using predicted adjustments to an item grouping.

Many large entities employ a dedicated team to review adjustments to collections of items (such as orders, quotes and deals), such as discounts or other specialized pricing for one or more items (e.g., products or services) in an order. The dedicated team may consider a number of performance characteristics of a collection of items, such as the revenue and/or margins associated with the collection of items and various characteristics associated with an account associated with the collection of items, such as a prior history. The pricing review, however, is often a difficult process that may consume a significant amount of time and resources.

Automated techniques, often based on ML models and/or statistical methods, have been developed to predict a quality score or grade associated with a collection of items that can expedite the process of reviewing proposed adjustments associated with a given collection of items. A number of features and/or key performance indicators (KPIs) associated with a given collection of items and/or account are applied to an ML model, in at least some embodiments, to determine a quality score for the given collection of items. The quality score can be applied to one or more thresholds, for example, to automatically approve or deny the collection of items, and/or to prioritize the collection of items for a manual review.

One or more aspects of the disclosure recognize that it is often difficult to evaluate a performance (e.g., a business impact) of such ML models, especially before such ML models are deployed into a production environment. There is typically no methodology to know a potential business impact of such ML models as there is no predictability. It is often difficult, for example, to predict how users will modify one or more parameters, associated with a given collection of items (sometimes referred to herein as an item grouping), based on an output of an ML model. Thus, any negative impacts of a candidate ML model cannot be evaluated until the candidate ML model is launched and observed. Currently, during a deployment of a new model, the potential business impact of the new model cannot be assessed until the new candidate model is deployed in a production environment and used sufficiently by users to make adjustments to a given collection of items based on an output of the new ML model.

There have been increasing concerns regarding the transparency and/or reliability of ML models, and in ensuring that such ML models can be reliably deployed. In one or more embodiments, selective ML model deployment techniques are provided that leverage predicted adjustments to an item grouping to assess a performance (e.g., a potential business impact) of one or more candidate ML models before the one or more candidate ML models are deployed.

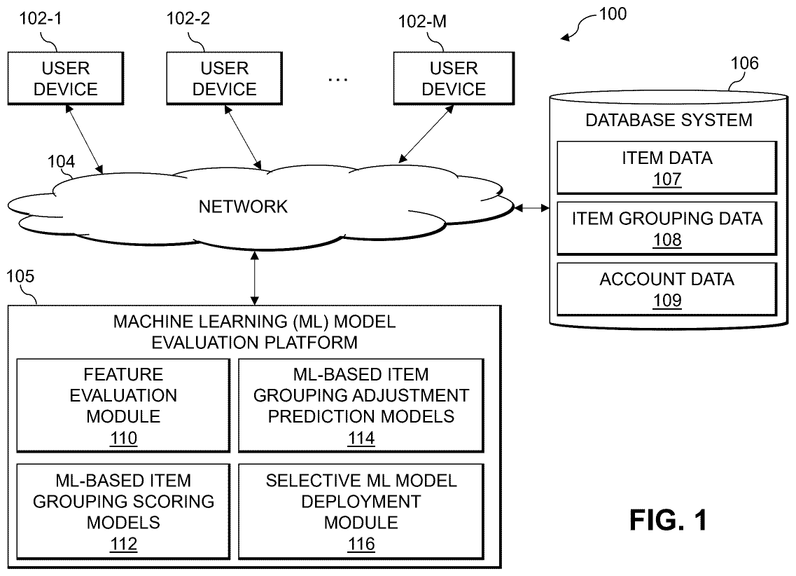

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an ML model evaluation platform 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.” The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

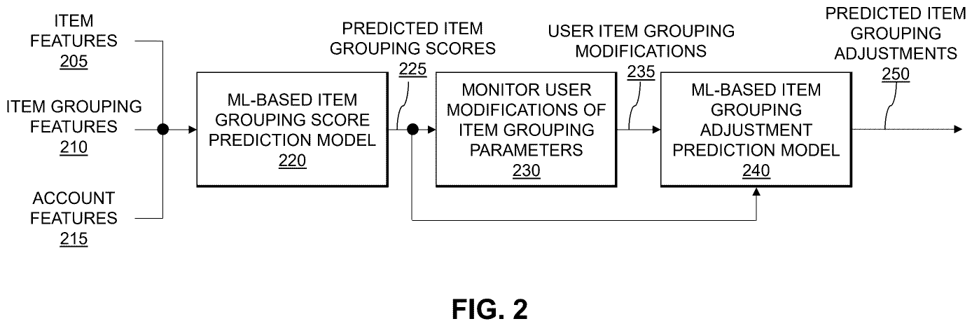

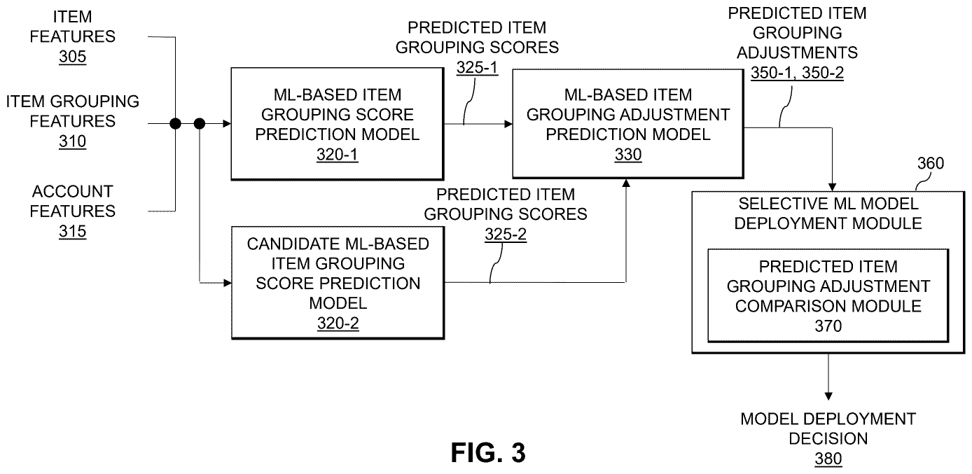

The ML model evaluation platform 105 may comprise a feature evaluation module 110, one or more ML-based item grouping scoring models 112, one or more ML-based item grouping adjustment prediction models 114 and a selective ML model deployment module 116. The feature evaluation module 110, in some embodiments, may generate feature values for one or more features, as discussed further below in conjunction with FIGS. 2 and 3, for example. In at least some embodiments, the ML-based item grouping scoring models 112 may generate one or more scores or grades for an item grouping (e.g., a deal or price quote), as discussed further below in conjunction with FIGS. 2 and 3, for example.

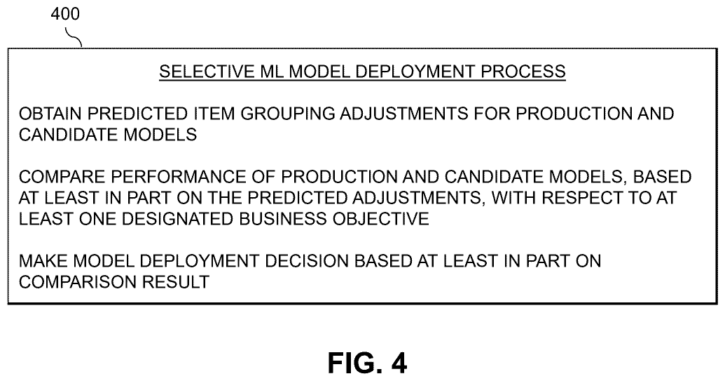

In one or more embodiments, the ML-based item grouping adjustment prediction models 114 may predict user modifications or adjustments to at least one item grouping, as discussed further below in conjunction with FIGS. 2 and 3, for example. The selective ML model deployment module 116 may compare a performance of two or more ML models, using the predicted user adjustments to an item grouping, generated by an ML-based item grouping adjustment prediction model 114, to make a deployment decision with respect to at least one of the two or more ML models, as discussed further below in conjunction with FIGS. 3 and 4, for example.

It is to be appreciated that this particular arrangement of elements 110, 112, 114 and/or 116 illustrated in the ML model evaluation platform 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

Additionally, the database system 106 may comprise one or more databases, such as an item database 107 (e.g., comprising information characterizing multiple items), an item grouping database 108 (e.g., comprising information characterizing item groupings, such as orders, deals and/or quotes), and an account database 109 (e.g., comprising information characterizing one or more accounts). The databases 107, 108 and 109 may be configured to store data, for example, in tables, in a known manner. While the databases 107, 108 and 109 are illustrated in FIG. 1 as comprising distinct databases, at least portions of the databases 107, 108 and 109 may be implemented using a single database (e.g., different parts of a single database). Example databases 107, 108 and 109, such as depicted in the present embodiment, can be implemented using one or more storage systems associated with the ML model evaluation platform 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the ML model evaluation platform 105 are one or more input-output devices, which illustratively comprise keyboards, displays or other types of input-output devices in any combination. Such input-output devices can be used, for example, to support one or more user interfaces to the ML model evaluation platform 105, as well as to support communication between ML model evaluation platform 105 and other related systems and devices not explicitly shown.

Additionally, the ML model evaluation platform 105 in the FIG. 1 embodiment is assumed to be implemented using at least one processing device. Each such processing device generally comprises at least one processor and an associated memory, and implements one or more functional modules for controlling certain features of the ML model evaluation platform 105.

More particularly, the ML model evaluation platform 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the ML model evaluation platform 105 to communicate over the network 104 with the user devices 102, and illustratively comprises one or more conventional transceivers.

It is to be understood that the particular set of elements shown in FIG. 1 for the ML model evaluation platform 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the ML model evaluation platforms 105 and at least portions of the database system 106 can be on and/or part of the same processing platform.

FIG. 2 illustrates a training of an ML-based item grouping adjustment prediction model 240 in accordance with an illustrative embodiment. In the example of FIG. 2, one or more item features 205, one or more item grouping features 210 and one or more account features 215, associated, for example, with historical item groupings (e.g., historical deals or orders) are applied to an ML-based item grouping score prediction model 220 (e.g., a current or production version of the ML-based item grouping score prediction model 220) that generates a predicted item grouping score 225 for each historical item grouping. In one or more embodiments, the ML-based item grouping score prediction model 220 may be implemented using one or more decision tree models, in order to provide explainability of the results (e.g., to explain why a given predicted score was assigned to a given item grouping).

In addition, in order to train the ML-based item grouping adjustment prediction model 240, one or more user modifications of one or more parameters of the historical item groupings are monitored in step 230. For example, based at least in part on the predicted item grouping score 225, one or more users may modify a discount associated with one or more of the historical item groupings (such as an order quote or another deal). The observed user item grouping modifications 235, that were monitored in step 230, are applied as labels for a supervised (or semi-supervised) training of the ML-based item grouping adjustment prediction model 240, along with the predicted item grouping score 225 for each historical item grouping.

The ML-based item grouping adjustment prediction model 240 learns to generate predicted item grouping adjustments 250 that may be used to compare a performance of two different ML models, as discussed further below in conjunction with FIG. 3, for example. In this manner, the observed user item grouping modifications 235, made in response to a given predicted item grouping score 225, for a given historical item grouping, from a current or prior version of the ML-based item grouping score prediction model 220, are used to generate training labels to train the ML-based item grouping adjustment prediction model 240.

In at least some embodiments, the ML-based item grouping adjustment prediction model 240 may be considered a user reward model and may be implemented using, for example, using one or more boosted trees, such as light gradient-boosting machines (lightGBM or LGBM).

FIG. 3 illustrates an evaluation of the ML-based item grouping scoring models of FIG. 1 in accordance with an illustrative embodiment. In the example of FIG. 3, one or more item features 305, one or more item grouping features 310 and one or more account features 315, associated, for example, with historical item groupings (e.g., historical deals or orders) are applied to ML-based item grouping score prediction models 320-1 and 320-2 (e.g., a current or production model 320-1 and a candidate model 320-2 that is being considered to replace the current model 320-1). For example, a candidate model 320-2 may be an update to the current model 320-1, such as an update to one or more considered features or other aspects to be considered by the candidate model 320-2. In other implementations, the ML-based item grouping score prediction models 320-1 and 320-2 can be two new models being considered for deployment.

The ML-based item grouping score prediction models 320-1 and 320-2 generate respective predicted item grouping scores 325-1 and 325-2 for each historical item grouping. The predicted item grouping scores 325-1 and 325-2 for each historical item grouping are applied to an ML-based item grouping adjustment prediction model 330 (e.g., that was trained in accordance with FIG. 2). ML-based item grouping adjustment prediction model 330 generates predicted item grouping adjustments 350-1 and 350-2, associated with the models 320-1 and 320-2, respectively.

One or more aspects of the disclosure recognize that the predicted item grouping adjustments 350-1 and 350-2 can be used to compare a performance or business impact of the models 320-1 and 320-2, respectively, in a production environment. A selective ML model deployment module 360, as discussed further below in conjunction with FIG. 4, for example, comprises a predicted item grouping adjustment comparison module 370 that compares the predicted item grouping adjustments 350-1 and 350-2 associated with the two models 320-1 and 320-2, to evaluate their relative performance, and to make a model deployment decision 380 (e.g., whether or not to deploy one or both of the models 320-1 and 320-2).

FIG. 4 illustrates exemplary pseudocode for a selective ML model deployment process 400 in accordance with an illustrative embodiment. In the example of FIG. 4, the predicted item grouping adjustments 350 (e.g., for the production and candidate models) are initially obtained. The selective ML model deployment process 400 compares the performance of the two models 320 (e.g., production and candidate models), based at least in part on the predicted item grouping adjustments 350, with respect to at least one designated business objective, such as one or more key performance indicators (KPIs). For example, assuming that the predicted item grouping adjustments 350 comprise discounts to sales quotes, the selective ML model deployment process 400 may evaluate a margin KPI that aggregate the discounts to sales quotes in the predicted item grouping adjustments 350 for the historical sales quotes, for each of the two models 320, and then compare the aggregated discounts for the two models 320.

In some embodiments, the selective ML model deployment process 400 may compare the performance of one or both models 320 being evaluated to a designated benchmark model that was shown to perform well in a production environment.

The selective ML model deployment process 400 then makes a model deployment decision 380 based at least in part on the comparison result. For example, the comparison may indicate that a first model (e.g., a candidate model) is performing significantly worse than a second model (e.g., a production model or benchmark model). Thus, the model deployment decision 380 may suggest refining the first model or otherwise preventing a release of the first model.

The selective ML model deployment process 400 may also evaluate, for example, an R² score and/or a mean absolute error (MAE) of the models. The R² score (sometimes referred to as a coefficient of determination) measures how well a model fits data. The R² score is typically in a range from 0 to 1, where higher values indicate a better fit. The MAE measures an average size of errors in predictions generated by a model.

The following data is an example of a first model (e.g., a candidate model) that is performing significantly worse than a second model (e.g., a production model or benchmark model). It is noted that less of a discount on a sales quote is more desirable for an organization, so a higher negative discount value is better:

| Predicted | Average | Benchmark | New Model | Model |
|---|---|---|---|---|
| Class | Discount | Model Discount | Discount | Difference |
| 0-0.02 | −0.71% | −$102,052.76 | −$40,040.31 | $62,012.45 |
| <−0.02 | −4.90% | −$161,155.11 | −$158,867.37 | $2,287.74 |
| Positive | 0.00% | $0.00 | $0.00 | $0.00 |
| Zero | 0.00% | $0.00 | $0.00 | $0.00 |

The following data is an example of a first model (e.g., a candidate model) that is performing better (e.g., a higher negative discount value) or in the threshold range of the production model (suggesting to proceed with releasing the first model, for example, to avoid concept drift or to consider keeping the production model).

| Predicted | Average | Benchmark | New Model | Model |
|---|---|---|---|---|
| Class | Discount | Model Discount | Discount | Difference |
| 0-0.02 | −0.71% | −$90,299.42 | −$90,299.42 | $0.00 |
| <−0.02 | −4.90% | −$83,213.26 | −$89,337.68 | −$6,124.43 |
| POSITIVE | 0.00% | $0.00 | $0.00 | $0.00 |
| ZERO | 0.00% | $0.00 | $0.00 | $0.00 |

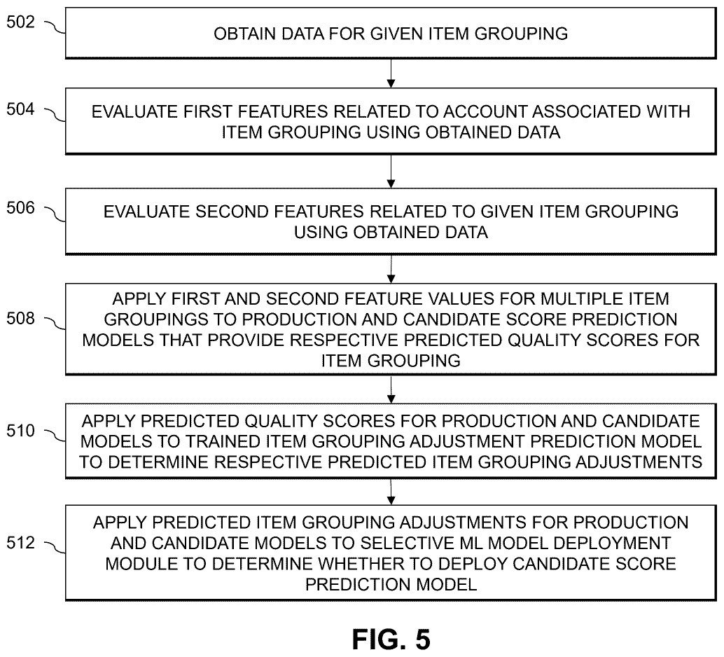

FIG. 5 is a flow diagram illustrating an exemplary implementation of a process for selective ML model deployment using predicted adjustments to an item grouping in accordance with an illustrative embodiment. In the example of FIG. 5, data for given item grouping is initially obtained in step 502. A set of first features and a set of second features related to account associated with the item grouping are evaluated in steps 504 and 506, respectively, using the obtained data.

The first and second feature values, associated with multiple item groupings, are applied in step 508 to production and candidate score prediction models (e.g., ML-based item grouping score prediction models 320-1 and 320-2, respectively) that provide respective predicted quality scores for the item grouping.

In step 510, the predicted quality scores for the production and candidate models, optionally along with additional information related to the given item grouping, are applied to the trained item grouping adjustment prediction model (e.g., ML-based item grouping adjustment prediction model 330 trained in accordance with FIG. 2) to determine respective predicted item grouping adjustments for the two models.

The predicted item grouping adjustments from step 510 for the production and candidate models are applied to the selective ML model deployment module 360 in step 512 to determine whether or not to deploy (or modify) the candidate score prediction model.

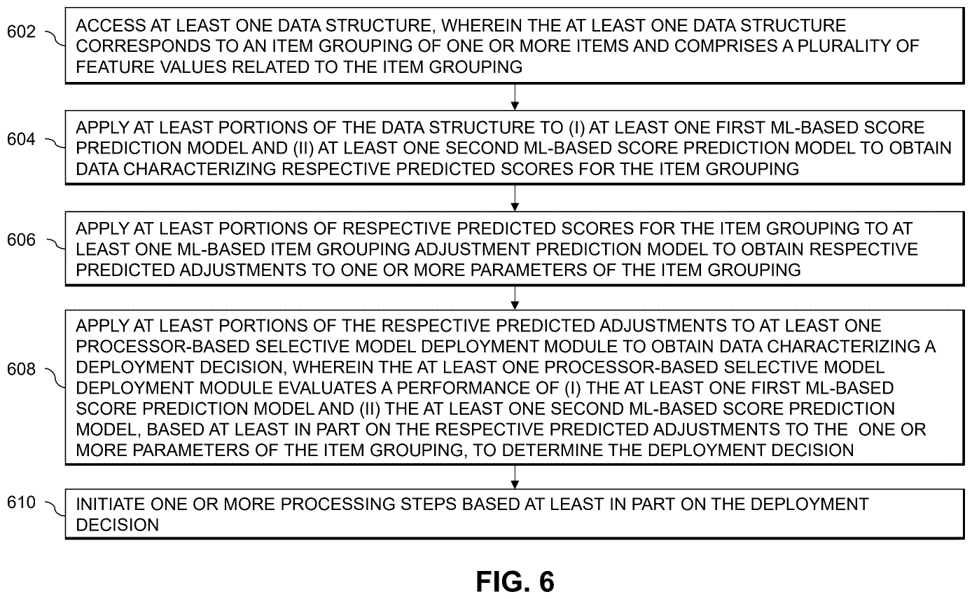

FIG. 6 is a flow diagram illustrating an exemplary implementation of a process for selective ML model deployment using predicted adjustments to an item grouping in accordance with an illustrative embodiment. In the example of FIG. 6, at least one data structure is accessed in step 602, where the at least one data structure corresponds to an item grouping of one or more items and comprises a plurality of feature values related to the item grouping.

At least portions of the data structure are applied in step 604 to (i) at least one first ML-based score prediction model and (ii) at least one second ML-based score prediction model to obtain data characterizing respective predicted scores for the item grouping. At least portions of the respective predicted scores for the item grouping are applied in step 606 to at least one ML-based item grouping adjustment prediction model to obtain respective predicted adjustments to one or more parameters of the item grouping.

At least portions of the respective predicted adjustments are applied in step 608 to at least one processor-based selective model deployment system to obtain data characterizing a deployment decision, wherein the at least one processor-based selective model deployment system evaluates a performance of (i) the at least one first ML-based score prediction model and (ii) the at least one second ML-based score prediction model, based at least in part on the respective predicted adjustments to the one or more parameters of the item grouping, to determine the deployment decision.

One or more processing steps are initiated in step 610 based at least in part on the deployment decision.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. In some embodiments, the data structures are specifically formatted or generated such that they are suitable for use as at least one of an input to and an output from an ML model. It should further be appreciated that “generating” a data structure may encompass, for example, populating an existing or previously-created data structure with one or more data items and that “accessing” a data structure may encompass, for example, obtaining a portion (e.g., one or more data items) of one or more data structures by means of a query, select or filter operation, for example.

In at least one embodiment, wherein the deployment decision indicates whether to deploy one or more of (i) the at least one first ML-based score prediction model and (ii) the at least one second ML-based score prediction model to a production environment. The at least one first ML-based score prediction model may comprise a production model and the at least one second ML-based score prediction model may comprise a candidate model.

In at least some embodiments, the at least one first ML-based score prediction model and/or the at least one second ML-based score prediction model are implemented, at least in part, using one or more decision tree models. The at least one ML-based item grouping adjustment prediction model may be implemented, at least in part, using one or more boosted tree models.

In one or more embodiments, wherein the at least one processor-based selective model deployment system evaluates one or more performance indicators to determine a respective performance of (i) the at least one first ML-based score prediction model and (ii) the at least one second ML-based score prediction model and determines the deployment decision based at least in part on a comparison of the respective performance of (i) the at least one first ML-based score prediction model and (ii) the at least one second ML-based score prediction model. The item grouping may correspond to an order quote for the one or more items.

In one embodiment, the one or more processing steps comprise at least one of: generating a notification related to the deployment decision, automatically modifying the at least one second ML-based score prediction model based at least in part on the deployment decision and causing an action to be performed in another system based at least in part on the deployment decision. The plurality of feature values may comprise a first feature group comprising one or more first feature values related to an entity associated with the item grouping and a second feature group comprising one or more second feature values related to the item grouping.

The particular processing operations and other network functionality described in conjunction with FIGS. 2 through 6, for example, are presented by way of illustrative example only, and should not be construed as limiting the scope of the disclosure in any way. Alternative embodiments can use other types of processing operations for selective ML model deployment using predicted adjustments to an item grouping. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

One or more embodiments of the disclosure provide improved methods, apparatus and computer program products for selective ML model deployment using predicted adjustments to an item grouping. The foregoing applications and associated embodiments should be considered as illustrative only, and numerous other embodiments can be configured using the techniques disclosed herein, in a wide variety of different applications.

It should also be understood that the disclosed techniques for selective ML model deployment using predicted adjustments to an item grouping, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for selective ML model deployment using predicted adjustments to an item grouping may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based selective ML model deployment engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based selective ML model deployment platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

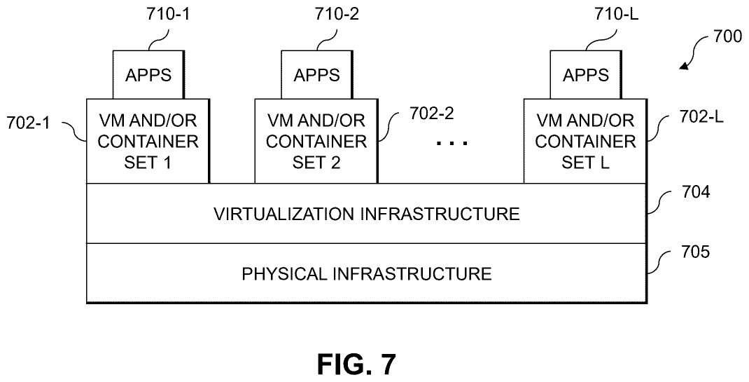

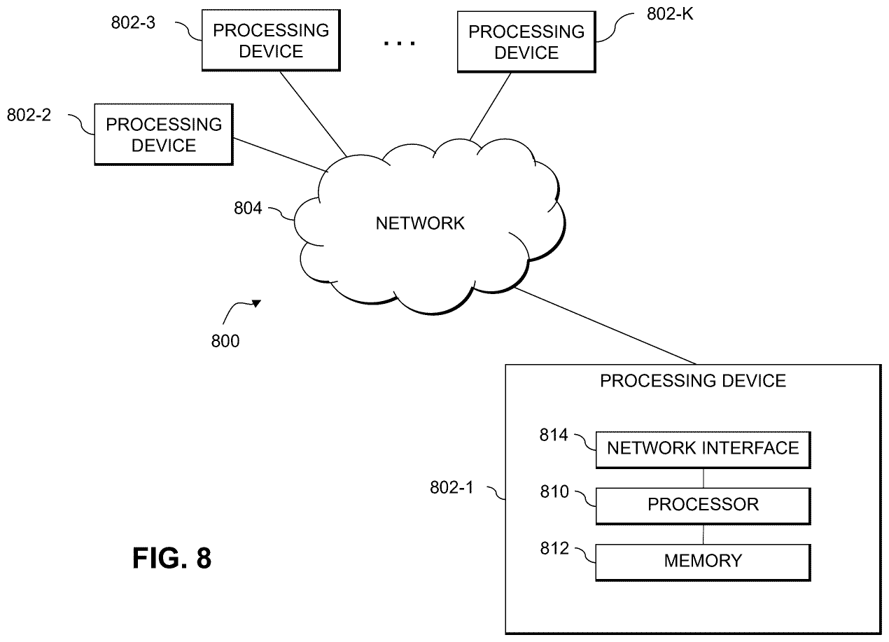

Illustrative embodiments of processing platforms will now be described in greater detail with reference to FIGS. 7 and 8. These platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. Such implementations can provide selective ML model deployment functionality of the type described above for one or more processes running on a given one of the VMs. For example, each of the VMs can implement control logic for selective ML model deployment and associated functionality for processing predicted adjustments to an item grouping to evaluate ML models.

An example of a hypervisor platform that may be used to implement a hypervisor within the virtualization infrastructure 704 is a compute virtualization platform which may have an associated virtual infrastructure management system such as server management software. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system. Such implementations can provide selective ML model deployment functionality of the type described above for one or more processes running on different ones of the containers. For example, a container host device supporting multiple containers of one or more container sets can implement one or more instances of control logic for selective ML model deployment and associated functionality for processing predicted adjustments to an item grouping to evaluate ML models.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises at least a portion of the given system and includes a plurality of processing devices, denoted 802-1, 802-2, 802-3, . . . 802-K, which communicate with one another over a network 804. The network 804 may comprise any type of network, such as a WAN, a LAN, a satellite network, a telephone or cable network, a cellular network, a wireless network such as WiFi or WiMAX, or various portions or combinations of these and other types of networks.

The processing device 802-1 in the processing platform 800 comprises a processor 810 coupled to a memory 812. The processor 810 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 812, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 7 or 8, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
accessing at least one data structure, wherein the at least one data structure corresponds to an item grouping of one or more items and comprises a plurality of feature values related to the item grouping;
applying at least portions of the data structure to (i) at least one first machine learning (ML)-based score prediction model and (ii) at least one second ML-based score prediction model to obtain data characterizing respective predicted scores for the item grouping;
applying at least portions of the respective predicted scores for the item grouping to at least one ML-based item grouping adjustment prediction model to obtain respective predicted adjustments to one or more parameters of the item grouping;
applying at least portions of the respective predicted adjustments to at least one processor-based selective model deployment system to obtain data characterizing a deployment decision, wherein the at least one processor-based selective model deployment system evaluates a performance of (i) the at least one first ML-based score prediction model and (ii) the at least one second ML-based score prediction model, based at least in part on the respective predicted adjustments to the one or more parameters of the item grouping, to determine the deployment decision; and
initiating one or more processing steps based at least in part on the deployment decision;
wherein the method is performed by at least one processing device comprising a processor coupled to a memory.

2. The method of claim 1, wherein the deployment decision indicates whether to deploy one or more of (i) the at least one first ML-based score prediction model and (ii) the at least one second ML-based score prediction model to a production environment.

3. The method of claim 1, wherein (i) the at least one first ML-based score prediction model and (ii) the at least one second ML-based score prediction model are implemented, at least in part, using one or more decision tree models.

4. The method of claim 1, wherein the at least one ML-based item grouping adjustment prediction model is implemented, at least in part, using one or more boosted tree models.

5. The method of claim 1, wherein the at least one processor-based selective model deployment system evaluates one or more performance indicators to determine a respective performance of (i) the at least one first ML-based score prediction model and (ii) the at least one second ML-based score prediction model and determines the deployment decision based at least in part on a comparison of the respective performance of (i) the at least one first ML-based score prediction model and (ii) the at least one second ML-based score prediction model.

6. The method of claim 1, wherein the one or more processing steps comprise at least one of: generating a notification related to the deployment decision, automatically modifying the at least one second ML-based score prediction model based at least in part on the deployment decision and causing an action to be performed in another system based at least in part on the deployment decision.

7. The method of claim 1, wherein (i) the at least one first ML-based score prediction model comprises a production model and the at least one second ML-based score prediction model comprises a candidate model, or (ii) the at least one first ML-based score prediction model and the at least one second ML-based score prediction model comprise respective candidate models.

8. The method of claim 1, wherein the plurality of feature values comprises a first feature group comprising one or more first feature values related to an entity associated with the item grouping and a second feature group comprising one or more second feature values related to the item grouping.

9. An apparatus comprising:
at least one processing device comprising a processor coupled to a memory;
the at least one processing device being configured to implement the following steps:
accessing at least one data structure, wherein the at least one data structure corresponds to an item grouping of one or more items and comprises a plurality of feature values related to the item grouping;
applying at least portions of the data structure to (i) at least one first machine learning (ML)-based score prediction model and (ii) at least one second ML-based score prediction model to obtain data characterizing respective predicted scores for the item grouping;
applying at least portions of the respective predicted scores for the item grouping to at least one ML-based item grouping adjustment prediction model to obtain respective predicted adjustments to one or more parameters of the item grouping;
applying at least portions of the respective predicted adjustments to at least one processor-based selective model deployment system to obtain data characterizing a deployment decision, wherein the at least one processor-based selective model deployment system evaluates a performance of (i) the at least one first ML-based score prediction model and (ii) the at least one second ML-based score prediction model, based at least in part on the respective predicted adjustments to the one or more parameters of the item grouping, to determine the deployment decision; and
initiating one or more processing steps based at least in part on the deployment decision.

10. The apparatus of claim 9, wherein the deployment decision indicates whether to deploy one or more of (i) the at least one first ML-based score prediction model and (ii) the at least one second ML-based score prediction model to a production environment.

11. The apparatus of claim 9, wherein (i) the at least one first ML-based score prediction model and (ii) the at least one second ML-based score prediction model are implemented, at least in part, using one or more decision tree models.

12. The apparatus of claim 9, wherein the at least one ML-based item grouping adjustment prediction model is implemented, at least in part, using one or more boosted tree models.

13. The apparatus of claim 9, wherein the at least one processor-based selective model deployment system evaluates one or more performance indicators to determine a respective performance of (i) the at least one first ML-based score prediction model and (ii) the at least one second ML-based score prediction model and determines the deployment decision based at least in part on a comparison of the respective performance of (i) the at least one first ML-based score prediction model and (ii) the at least one second ML-based score prediction model.

14. The apparatus of claim 9, wherein the plurality of feature values comprises a first feature group comprising one or more first feature values related to an entity associated with the item grouping and a second feature group comprising one or more second feature values related to the item grouping.

15. A non-transitory processor-readable storage medium having stored therein program code of one or more software programs, wherein the program code when executed by at least one processing device causes the at least one processing device to perform the following steps:
accessing at least one data structure, wherein the at least one data structure corresponds to an item grouping of one or more items and comprises a plurality of feature values related to the item grouping;
applying at least portions of the data structure to (i) at least one first machine learning (ML)-based score prediction model and (ii) at least one second ML-based score prediction model to obtain data characterizing respective predicted scores for the item grouping;
applying at least portions of the respective predicted scores for the item grouping to at least one ML-based item grouping adjustment prediction model to obtain respective predicted adjustments to one or more parameters of the item grouping;
applying at least portions of the respective predicted adjustments to at least one processor-based selective model deployment system to obtain data characterizing a deployment decision, wherein the at least one processor-based selective model deployment system evaluates a performance of (i) the at least one first ML-based score prediction model and (ii) the at least one second ML-based score prediction model, based at least in part on the respective predicted adjustments to the one or more parameters of the item grouping, to determine the deployment decision; and
initiating one or more processing steps based at least in part on the deployment decision.

16. The non-transitory processor-readable storage medium of claim 15, wherein the deployment decision indicates whether to deploy one or more of (i) the at least one first ML-based score prediction model and (ii) the at least one second ML-based score prediction model to a production environment.

17. The non-transitory processor-readable storage medium of claim 15, wherein (i) the at least one first ML-based score prediction model and (ii) the at least one second ML-based score prediction model are implemented, at least in part, using one or more decision tree models.

18. The non-transitory processor-readable storage medium of claim 15, wherein the at least one ML-based item grouping adjustment prediction model is implemented, at least in part, using one or more boosted tree models.

19. The non-transitory processor-readable storage medium of claim 15, wherein the at least one processor-based selective model deployment system evaluates one or more performance indicators to determine a respective performance of (i) the at least one first ML-based score prediction model and (ii) the at least one second ML-based score prediction model and determines the deployment decision based at least in part on a comparison of the respective performance of (i) the at least one first ML-based score prediction model and (ii) the at least one second ML-based score prediction model.

20. The non-transitory processor-readable storage medium of claim 15, wherein the plurality of feature values comprises a first feature group comprising one or more first feature values related to an entity associated with the item grouping and a second feature group comprising one or more second feature values related to the item grouping.
